(19) United States
(12) Patent Application Publication
(10) Pub. No.: US 2015/0352696 A1
(43) Pub. Date: Dec. 10, 2015

(54) WRENCH

(71) Applicant: HANGZHOU GREAT STAR TOOLS CO., LTD., Hangzhou City (CN)

(72) Inventor: Min Wang, Hangzhou City (CN)

(21) Appl. No.: 14/369,968

(22) PCT Filed: Jun. 6, 2014
(86) PCT No.: PCT/CN2014/079366

§ 371 Date: Sep. 25, 2014

(51) Int. Cl. B25B 13/46; B25B 13/14

(52) U.S. Cl. CPC B25B 13/46; B25B 13/14

(57) ABSTRACT

The invention provides a wrench, includes a body, a fixed jaw, a movable jaw, a slidable connecting member and a handle which is rotatably connected with the body. The movable jaw forms a slidable connection with the body via the slidable connecting member. The wrench includes a jaw locking mechanism which is rotatably connected with the handle. The jaw locking mechanism is used for restricting the slidable connecting member to move towards to and away from the fixed jaw relative to the body. The invention provides a wrench of which the distance between the jaws is capable of increasing. The fixed jaw and the movable jaw are capable of slipping away from the apexes of the workpiece, which realizes rotating the workpiece continuously and repetitiously. Thus the work efficiency of the wrench is improved. The wrench has a simple structure, and it is capable of enduring larger torque. At the same time, simple structure also simplifies the manufacturing process of the wrench, reducing the costs of manufacture. The first flexible member is internally installed in the body, which makes the first flexible member avoid contacting oil stain in use and the wrench provided by the invention more beautiful at the same time. The worm gear of the wrench uses a double start thread structure, which reduces the time of adjusting the distance between jaws and increases the bearable torque of the worm gear.

### FIELD OF THE INVENTION

The present invention relates to a wrench, belonging to the field of hand tools.

### DESCRIPTION OF THE PRIOR ART

An adjustable wrench generally includes a fixed jaw and a movable jaw used for clamping a workpiece, and the movable jaw can move towards and away from the fixed jaw. By means of adjusting the distance between the fixed jaw and the movable jaw, the wrench can clamp a series of varisized workpieces. Rotating the handle, the wrench can fasten or loosen a workpiece.

When using an ordinary wrench, users adjust the distance between the fixed jaw and the movable jaw to place the wrench on a workpiece. In most operating environment, the handle of the wrench can only be rotated a small angle. So the users need to rotate multiple times continuously to fasten or loosen a workpiece. Between two rotations, the users need to stop and move the wrench away from the workpiece temporarily and place the wrench on the workpiece again to continue the operation. Sometimes they need another hand for assistance, so the operation is very inconvenient.

A ratchet wrench is capable of simplifying the operation. Between multiple rotations, the ratchet wrench need not to be moved away from a workpiece and placed on the workpiece.

However it is not easy to combine the ratchet function with the adjustable function in a single wrench, and it leads to a relatively complex structure, making the tool more difficult to manufacture and the costs higher. Moreover when the torque is greater, the wrench can be damaged.

Thus, a person skilled in the art devotes to a ratchet wrench with simple structure, in order to rotate a workpiece quickly and improve the work efficiency of the wrench.

### SUMMARY OF THE INVENTION

In view of the above defects of the prior art, the technical problem to be solved by the invention is to provide a wrench with simple structure, realizing rotating a workpiece continuously and repeatedly without moving the wrench away from and placing the wrench on the workpiece again, thus improving the work efficiency of the wrench. Meanwhile because of the simple structure, the wrench is capable of being made firm. When the torque is greater, the wrench is not easy to be damaged. Besides, the simple structure also simplifies the manufacturing process of the wrench, and reduces the costs of manufacture.

The invention provides a wrench, comprising a body, a fixed jaw which is connected with the body fixedly, a movable jaw, a slidable connecting member and a handle which is rotatably connected with the body. The movable jaw forms a slidable connection with the body via the slidable connecting member, wherein, the wrench comprises a jaw locking mechanism which is rotatably connected with a handle. The jaw locking mechanism is used for restricting the slidable connecting member to move towards or away from the fixed jaw relative to the body.

When the handle is rotated anticlockwise relative to the body, the handle drives the jaw locking mechanism, changing from a locked state to an unlocked state. The movable jaw is capable of moving away from the fixed jaw under an external force.

The wrench provided by the invention is used for the standard right hand thread workpiece.

When the handle is rotated anticlockwise relative to the body, the handle drives the jaw locking mechanism via the rotatable connection between the handle and the body, switching the jaw locking mechanism from the locked state to the unlocked state, making the slidable connecting member move towards or away from the fixed jaw relative to the body, thus making the movable jaw move towards or away from the fixed jaw under the external force.

At the moment the handle continues to be rotated anticlockwise, and the handle is not rotated relative to the body any more, but the jaws rotate relative to a workpiece. Usually a workpiece is a hexagon nut, and the jaws rotate to the position clamping the relative apexes of the hexagon nut from the position clamping the relative surfaces of the hexagon nut. In the process, with the size of the hexagon nut clamped between the jaws getting larger, the hexagon nut applies forces to the movable jaw and the fixed jaw. The movable jaw moves away from the fixed jaw under the forces, thus increasing the distance between the movable jaw and the fixed jaw, so that the jaws are capable of slipping away from the apexes of the workpiece and reaching the next position clamping the relative surfaces of the hexagon nut. In the position, the handle is rotated along the direction of fastening the workpiece relative to the body, and that is, rotating the handle clockwise. With the handle rotating, the workpiece is fastened.

If the workpiece needs to continue to be fastened, the handle is rotated anticlockwise again, and with the distance between the fixed jaw and the movable jaw increasing, the fixed jaw and the movable jaw are capable of slipping away from the apexes of the workpiece. The handle is rotated clockwise again, the workpiece is fastened to realize rotating the workpiece continuously and repetitiously without moving the wrench away from the workpiece and placing the wrench on the workpiece again. Work efficiency of the wrench is improved.

It can be understood that simply using the wrench provided by the invention inversely is capable of fastening a left hand thread workpiece or loosening a right hand thread workpiece.

The description below aims at a right hand thread workpiece.

Further, the body and the fixed jaw are integrally formed.

Further, the jaw locking mechanism is a knockout pin.

Using the knockout pin as the jaw locking mechanism is capable of manufacturing firm wrenches. When the torque is greater, the wrench is not easy to be damaged. At the same time the simple structure also simplifies the manufacturing process of the wrench and reduces the costs of manufacture.

Further, the movable jaw and the body form a slidable connection via a pin axle and a worm gear. The first end of the pin axle, which is far away from the fixed jaw, has an annular groove around the surface of the pin axle. It is in a locked state when the first end of the knockout pin is embedded in the annular groove. And it is in an unlocked state when the first end of the knockout pin is detached from the annular groove.

The wrench provided by the invention is in the locked state when the first end of the knockout pin is embedded in the annular groove. At the moment, the jaws rotate to the position of clamping the relative apexes of the hexagon nut from the position of clamping the relative surfaces of the hexagon nut. In the process, with the size of the hexagon nut clamped between the jaws getting larger, the hexagon nut applies external forces to the movable jaw and the fixed jaw. The first end of the knockout pin embedded in the annular groove limits the movement of the pin axle, and limits the movable jaw moving away from the fixed jaw. The distance between the movable jaw and the fixed jaw cannot be increased, so that the jaws are not capable of slipping away from the apexes of the workpiece to the next position of clamping the relative surfaces of the hexagon nut.

It is in an unlocked state when the first end of the knockout pin is detached from the annular groove. The hexagon nut applies external forces to the movable jaw and the fixed jaw, so that the movable jaw moves away from the fixed jaw and the distance between the movable jaw and the fixed jaw is increased. Thus, the jaws are capable of slipping away from the apexes of the workpiece to reach the next position of clamping the relative surfaces of the hexagon nut.

Further, the worm gear is arranged in the cavity of the body. The length of the worm gear is less than that of the cavity in the axial direction of the pin axle. When the movable jaw is under an external force, it is capable of moving away from the fixed jaw.

Further, a first flexible member is sleeved on a first end of the pin axle, so as to make the jaws reset automatically without external forces.

Further, the first flexible member is arranged in a hole of the body. The first flexible member is inside the body, so that the first flexible member avoids contacting with oil stain in use and the wrench provided by the invention is more beautiful at the same time.

Further, a second end of the knockout pin and a first recess of the handle form a rotatable connection. When the handle is rotated anticlockwise relative to the body, via the rotatable connection between the second end of the knockout pin and the first recess of the handle, the handle drives the knockout pin, so that the first end of the knockout pin moves out of the annular groove of the pin axle, and the jaw locking mechanism switches from the locked state to the unlocked state.

Further, the second end of the knockout pin is a spherical structure. Using the spherical structure ensures that the rotatable connection between the knockout pin and the handle is firm and reliable. When the torque is greater, the wrench cannot be damaged easily.

Further, the second end of the knockout pin is a cylindrical structure. The axis of the cylinder is perpendicular to the axis of the knockout pin. Using the cylindrical structure ensures that the rotatable connection between the knockout pin and the handle is firm and reliable. When the torque is greater, the wrench cannot be damaged easily.

Further, the first recess of the handle comprises an arc-shaped profile, so that the rotatable connection between the knockout pin and the handle rotates flexibly.

Further, the corresponding central angle of the arc-shaped profile is larger than 180 degrees, so that the second end of the knockout pin is not easy to move out of the first recess of the handle and further ensures that the rotatable connection between the knockout pin and the handle is firm and reliable. When the torque is greater, the wrench cannot be damaged easily.

Further, a side of the handle which faces to a first side of the body comprises a first side paralleling to the first side of the body and a second side which forms an angle which is less than 5 degrees with the first side of the body.

Since the first side of the handle is parallel to the first side of the body, the handle cannot be rotated clockwise relative to the body. That is, when the handle is rotated clockwise, the handle cannot switch the jaw locking mechanism from the locked state to the unlocked state, merely fastens the workpiece.

Since the second side of the handle forms an angle which is less than 5 degrees with the first side of the body, the handle can be rotated anticlockwise relative to the body. Then the handle switches the jaw locking mechanism from the locked state to the unlocked state. Thus the movable jaw is capable of moving away from the fixed jaw, the distance between the fixed jaw and the movable jaw is increased, and the fixed jaw and the movable jaw are capable of slipping away from the apexes of the workpiece.

Further, a blind hole is arranged in the second side of the handle, and a second flexible member is arranged in the blind hole. An elastic force provided by the second flexible member keeps the jaw locking mechanism in the locked state; avoiding unreliable locking in use.

Further, the worm gear has a double-start thread structure, which reduces the time of adjusting the distance between the jaws and at the same time increases the bearable torque of the worm gear.

Further, the wrench comprises a handle locking mechanism. While the handle locking mechanism is in a locked position, the handle is not capable of rotating relative to the body. While the handle locking mechanism in the unlocked position, the handle is capable of rotating relative to the body.

The wrench provided by the invention comprises the handle locking mechanism. While the handle locking mechanism is in the locked position, the handle is not capable of rotating relative to the body. The wrench is the same as the ordinary wrench. The workpiece is fastened when the handle is rotated clockwise, and the workpiece is loosened when the handle is rotated anticlockwise. While the handle locking mechanism is in the unlocked position, the handle is capable of rotating relative to the body. The workpiece is fastened when the handle is rotated clockwise. The jaw locking mechanism switches from the locking state to the unlocking state when the handle is rotated anticlockwise, so that the movable jaw is capable of moving away from the fixed jaw. Thus the distance between the fixed jaw and the movable jaw is increased, and the fixed jaw and the movable jaw are capable of slipping away from the apexes of the workpiece.

Further, the handle locking mechanism comprises a push button and a fixture block. The push button is used for making the handle locking mechanism move between the locked position and the unlocked position. The fixture block is used for restricting the rotation of the handle relative to the body.

Further, the fixture block matches with a second recess of the handle, restricting the rotation of the handle relative to the body.

Further, the cross section of the fixture block is right angle trapezoid.

Further, the profile of the cross section of the second recess is a right angle which is matched with the right angle of the right angle trapezoid of the fixture block.

Compared with the prior art, the wrench provided by the invention has following beneficial effects.

(1) When the handle is rotated anticlockwise relative to the body, the jaw locking mechanism switches from the locked state to the unlocked state. With the distance between the fixed jaw and the movable jaw increasing under the external force, the fixed jaw and the movable jaw are capable of slipping away from the apexes of the workpiece, which realizes rotating the workpiece continuously and repetitiously without moving away the wrench from the workpiece and placing the wrench on the workpiece again. Work efficiency of the wrench is improved.

(2) The structure is simple, being capable of bearing greater torque, simplifying the manufacturing process at the same time, and reducing the costs of manufacture.

(3) The first flexible member is internal, so that the first flexible member avoid contacting with oil stain in use and the wrench is more beautiful at the same time.

(4) The worm gear has a double-start thread structure, which reduces the time of adjusting the distance between the jaws and at the same time increases the bearable torque of the worm gear.

Referencing to the figures, the conception, detailed structure and the technical effects of the invention will be illustrated further below for understanding the purpose, characteristic and effect adequately.

### BRIEF DESCRIPTION OF THE DRAWINGS

FIG. 1 is a front view of the wrench in an embodiment of the present invention.

FIG. 2 is a cross sectional view of the body of the wrench shown in FIG. 1.

FIG. 3 is a partial cross sectional view of the jaw locking mechanism of the wrench shown in FIG. 1, and the jaw locking mechanism is in the locked state.

FIG. 4 is a structural schematic view of the movable jaw of the wrench shown in FIG. 1.

FIG. 5 is a connection schematic view of the jaw locking mechanism of the wrench shown in FIG. 1.

FIG. 6 is a partial cross sectional view of the jaw locking mechanism of the wrench shown in FIG. 1, and the jaw locking mechanism is in the unlocked state.

FIG. 7 is a partial cross sectional view of the handle locking mechanism of the wrench shown in FIG. 1, and the handle locking mechanism is in the locked position.

FIG. 8 is a partial cross sectional view of the handle locking mechanism of the wrench shown in FIG. 1, and the handle locking mechanism is in the unlocked position.

FIG. 9 is a partial cross sectional view of the handle locking mechanism of the wrench shown in FIG. 1, and the handle locking mechanism is in the locked position.

### DETAILED DESCRIPTION OF THE PREFERRED EMBODIMENTS

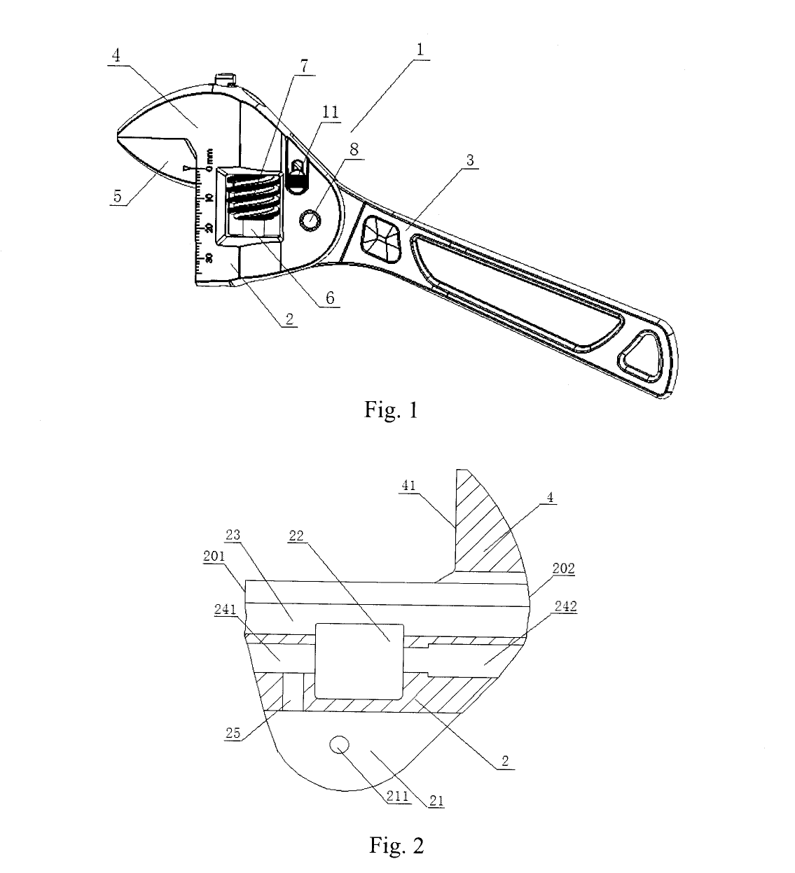

As shown in FIG. 1, a wrench 1 in an embodiment of the present invention comprises a body 2, a handle 3, a fixed jaw 4, a movable jaw 5 and a knockout pin 10.

The size of the handle 3 is designed so that the handle 3 is suitable for holding. The handle 3 includes injection molding casing to improve the comfort of holding.

The fixed jaw 4 is connected fixedly with the body 2. And the fixed jaw 4 and the body 2 are also formed integrally. In the embodiment, the fixed jaw 4 and the body 2 formed integrally.

The body 2, the fixed jaw 4 and the movable jaw 5 can be made from cast steel or other high-strength material.

As shown in FIG. 2, the fixed jaw 4 includes a surface of the jaw 41, and the surface of the jaw 41 touches a workpiece when the wrench works. The workpiece mentioned here includes any equipment, component or fastener which can be clamped by the wrench 1. Typical workpieces are fasteners using torque, such as screws, hexagon nuts, pipe fittings and so on.

The body 2 includes a cavity 22 of which the shape is approximately rectangle.

The body 2 includes an elongated sliding groove 23. The sliding groove 23 extends to the position of the body 2 under the fixed jaw 4 from a side 201 of the body 2. In the embodiment, the sliding groove 23 extends to the other side 202 of the body 2, and in this way both ends of the sliding groove 23 are in an open status. The sliding groove 23 has an opening along the upper edge, which is towards the fixed jaw 4, so as to contain the movable jaw 5. The sliding groove 23 is arranged that the movable jaw 5 moves towards and away from the fixed jaw 4 along the direction which is perpendicular to the surface of the jaw 41 of the fixed jaw 4. The sliding groove 23 is connected with the cavity 22.

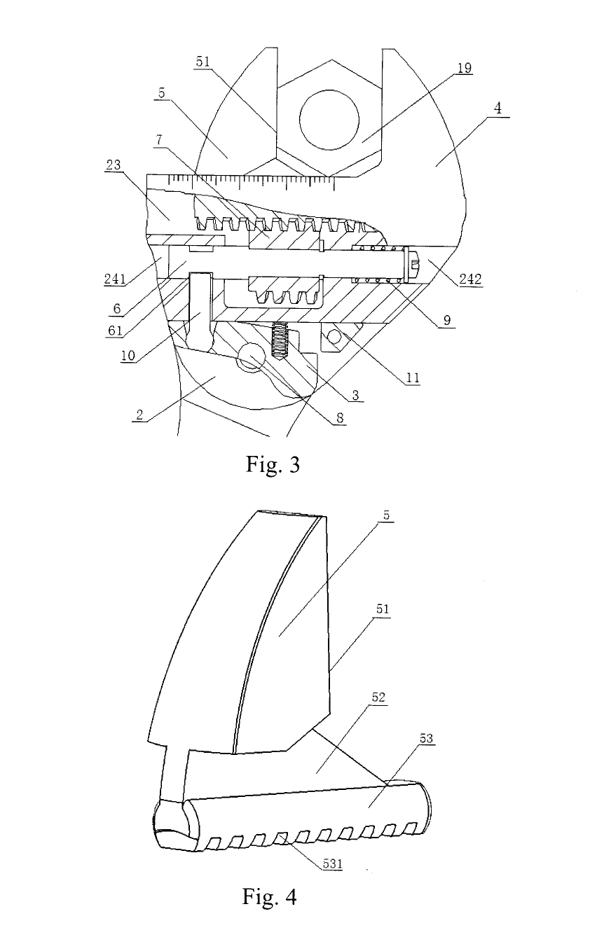

As shown in FIG. 3, the movable jaw 5 is installed on the body 2, forming a slidable connection with the body 2. The movable jaw 5 includes a surface of the jaw 51 which faces to the surface of the jaw 41 of the fixed jaw 4. The surface of the jaw 51 touches the workpiece when the wrench works. The workpiece here is a hexagon nut 19 which is clamped between the surface of the jaw 51 and the surface of the jaw 41.

As shown in FIG. 4, the movable jaw 5 includes a neck 52 and a flange 53, and the flange 53 is capable of sliding in the sliding groove 23. Since the movable jaw 5 has the neck 52, the sliding groove 23 has the similar cross section of which the size is bigger. When the movable jaw 5 moves towards and away from the fixed jaw 4, the movable jaw 5 can't move out of the opening at the upper edge of the sliding groove 23.

The dentation structure on the flange 53 constitutes the rack 531 which extends from the sliding groove 23 to the cavity 22.

One or two ends of the sliding groove 23 can be arranged with fixture block(s), which can prevent the movable jaw 5 from slipping away from the sliding groove 23.

As shown in FIG. 3, the worm gear 7 is arranged in the cavity 22, sleeving over the pin axle 6.

One end of the pin axle 6 is arranged in a through-hole 241 which extends from the side 201 of the body 2 to the cavity 22, and the other end of the pin axle 6 is arranged in a through-hole 242 which extends from the cavity 22 to the side 202 of the body 2.

The rack 531 of the flange 53 of the movable jaw 5 engages with the worm gear 7. In that way, the rotation of the worm gear 7 changes into the movement of the movable jaw 5 towards or away from the fixed jaw 4.

In the axial direction of the pin axle 6, the length of the worm gear 7 is less than that of the cavity 22. With the external force acting on the surface of the jaw 51 of the movable jaw 5, the movable jaw 5 drives the worm gear 7 and the pin axle 6 to move away from the fixed jaw 4 via the rack 531. The distance between the surface of the jaw 51 of the movable jaw 5 and the surface of the jaw 41 of the fixed jaw 4 can be increased.

The pin axle 6 is arranged in one end of the through-hole 242, sleeved by a first flexible member. The first flexible member in the embodiment is a spring 9. The through hole 242 includes two parts with different diameters. The diameter of the through hole of the part near the cavity 22 is smaller than that of the part far away from the cavity 22 which containing the pin axle 6 sleeved by the first flexible member.

With no external force acting, the spring 9 is used for resetting the pin axle 6 automatically, thereby resetting the movable jaw 5.

The spring 9 is arranged in the through-hole 242 of the body 2, which avoids the spring 9 contacting with oil stain in use and makes the wrench provided by the invention more beautiful at the same time.

The end of the pin axle 6 arranged in the through-hole 241 has an annular groove 61.

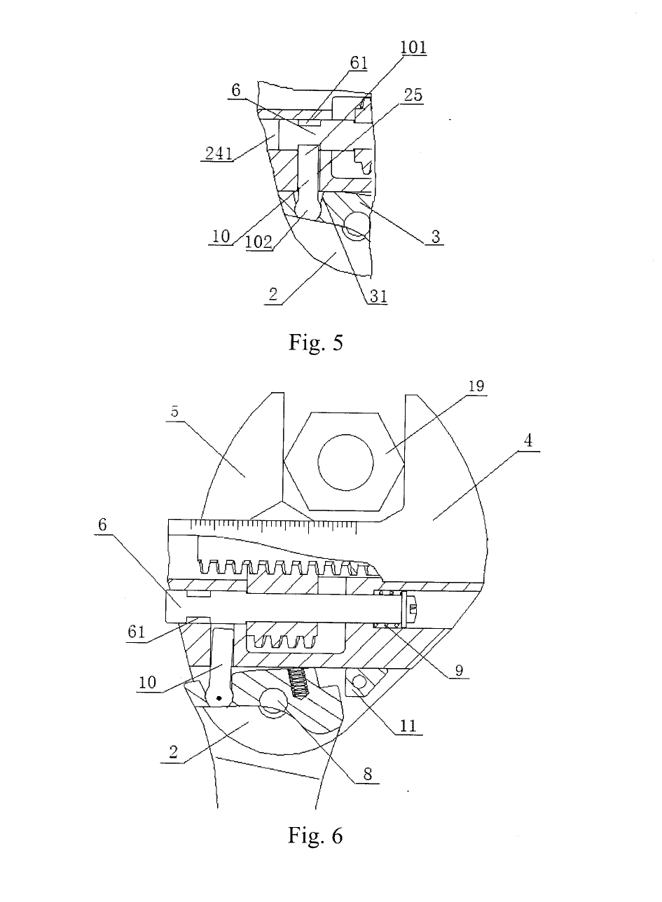

As shown in FIG. 5, the second end 102 of the knockout pin 10 is arranged in the first recess 31 of the handle 3. The knockout pin 10 is capable of rotating relative to the handle 3. The knockout pin 10 passes through the through-hole 25 of the body 2. The first end 101 of the knockout pin 10 is arranged in the annular groove 61 of the pin axle 6, and the jaw locking mechanism is in the locked state. The first end 101 of the knockout pin 10 moves out of the annular groove 61 of the pin axle 6, and the jaw locking mechanism is in the unlocked state.

When the handle 3 rotates anticlockwise relative to the body 2, via the rotatable connection between the second end 102 of the knockout pin 10 and the recess 31 of the handle 3, the handle drives the knockout pin 10. Thus the first end 101 of the knockout pin moves out of the annular groove 61 of the pin axle 6, and the jaw locking mechanism switches from the locked state to unlocked state.

The wrench in the embodiment is used for the standard right hand thread fastener, and the workpiece is the hexagon nut 19.

As shown in FIG. 3, the movable jaw 5 and the fixed jaw 4 clamp the relative surfaces of the hexagon nut 19. When the handle 3 is rotated anticlockwise relative to the body 2, the handle 3 drives the knockout pin 10 via the rotatable connection between the handle 3 and the body 2, which switches the jaw locking mechanism from the locked state to the unlocked state.

At the moment the handle 3 is rotated anticlockwise continuously, and the handle cannot be rotated relative to the body any more. And the jaws are rotated relative to the hexagon nut 19. The jaws are rotated to the position clamping the relative apexes of the hexagon nut 19 from the position clamping the relative surfaces of the hexagon nut 19. As shown in FIG. 6, in the process, with the size of the hexagon nut 19 clamped between the jaws getting larger, the hexagon nut 19 applies external forces to the movable jaw 5 and the fixed jaw 4. Under the forces, the movable jaw 5 can move away from the fixed jaw 4, thus increasing the distance between the movable jaw and the fixed jaw, thereby the jaws are capable of slipping away from the apexes of the hexagon nut 19, reaching the next position of clamping the relative surfaces of the hexagon nut 19. In the position, the handle 3 is rotated in the direction of fastening the workpiece relative to the body 2, and that is rotating the handle clockwise. With the handle 2 rotating, the hexagon nut 19 is fastened.

If the hexagon nut 19 needs to be fastened continuously, the handle 3 is rotated anticlockwise again, and with the distance between the fixed jaw 4 and the movable jaw 5 increasing, the fixed jaw 4 and the movable jaw 5 are capable of slipping away from the apexes of the hexagon nut 19. The handle 3 is rotated clockwise again; the hexagon nut 19 is fastened to realize rotating the hexagon nut 19 continuously and repetitiously without moving the wrench away from the hexagon nut 19 and placing the wrench on the workpiece again. Work efficiency of the wrench is improved.

It can be understood that simply using the wrench provided by the invention inversely is capable of fastening a left hand thread workpiece or loosening a right hand thread workpiece.

The second end of the knockout pin 10 is a spherical structure. Using the spherical structure ensures that the rotatable connection between the knockout pin 10 and handle 3 is firm and reliable. When the torque is greater, the wrench cannot be damaged easily.

The second end 102 of the knockout pin 10 is a cylindrical structure. The axis of the cylinder is perpendicular to that of the knockout pin 10. Using the cylindrical structure ensures that the rotatable connection between the knockout pin and the handle is firm and reliable. When the torque is greater, the wrench cannot be damaged easily.

The first recess 31 of the handle 3 includes an arc-shaped profile, which makes the rotatable connection between the knockout pin 10 and the handle 3 rotate flexibly.

The corresponding central angle of the arc-shaped profile is larger than 180 degrees, which makes the second end 102 of the knockout pin 10 not easy to move out of the first recess 31 of the handle 3 and further ensures that the rotatable connection between the knockout pin 10 and handle 3 is firm and reliable. When the torque is greater, the wrench cannot be damaged easily.

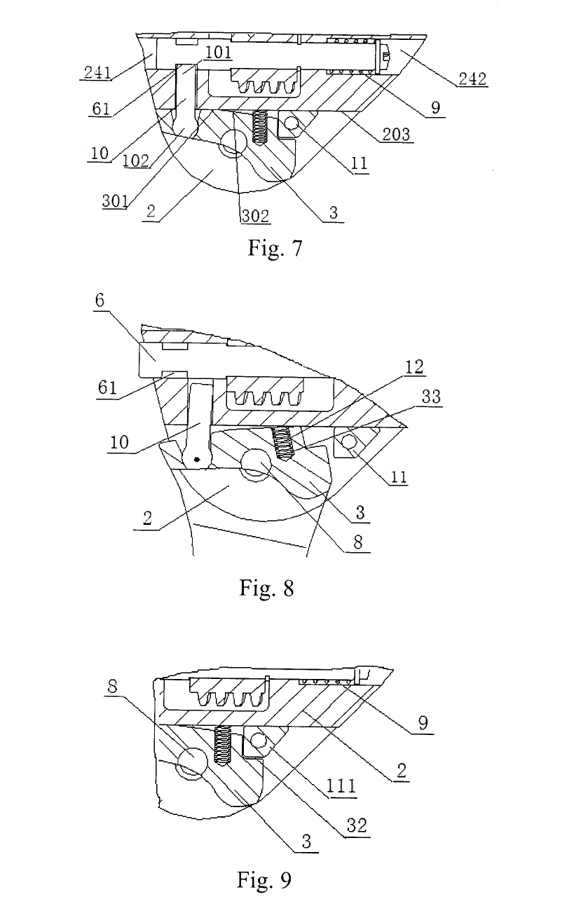

As shown in FIG. 7, the side of the handle 3 which faces to a first side 203 of the body 2 includes a first side 301 which is parallel to the first side 203 of the body 2 and a second side 302 which forms an angle which is less than 5 degrees with the first side 203 of the body 2.

Since the first side 301 of the handle 3 is parallel to the first side 203 of the body 2, the handle 3 cannot be rotated clockwise relative to the body 2. That is, when the handle 3 is rotated clockwise, the handle 3 cannot switch the jaw locking mechanism from the locked state to unlocked state, merely fastens the workpiece.

Since the second side 302 of the handle 3 forms an angle which is less than 5 degrees with the first side 203 of the body 2, the handle 3 can be rotated anticlockwise relative to the body 2. Then the handle 3 switches the jaw locking mechanism from the locked state to the unlocked state, so that the movable jaw 5 is capable of moving away from the fixed jaw 4. Thus the distance between the fixed jaw 4 and the movable jaw 5 is increased, and the fixed jaw and the movable jaw are capable of slipping away from the apexes of the hexagon nut 19.

A blind hole 33 is arranged in the second side 302 of the handle 3, and a second flexible member 12 is arranged in the blind hole 33. The elastic force provided by the second flexible member 12 keeps the knockout pin in locked state, which avoids unreliable locking in use.

As shown in FIG. 1, the wrench provided by the invention includes a handle locking mechanism. If the users do not need to use the function of ratchet, the handle locking mechanism can be set in the locked position, which is near a locating pin 8.

The handle locking mechanism 11 is installed in the body 2 via the slot hole of the flange of the body 2.

When the handle locking mechanism 11 is placed at an end of the slot hole which is near the locating pin 8, the handle locking mechanism 11 is in the locked position. As shown in FIG. 7, the handle 3 cannot be rotated relative to the body 2. When the handle locking mechanism 11 is placed at an end of the slot hole which is far away from the locating pin 8, the handle locking mechanism 11 is in the unlocked position. As shown in FIG. 8, the handle 3 is capable of rotating around the locating pin 8 relative to the body 2.

The handle locking mechanism includes a push button, a fixture block 111 and a spring. The push button is used for making the handle locking mechanism switch between the locked position and the unlocked position. As shown in FIG. 9, the cross section of the fixture block 111 is right angle trapezoid. The profile of the cross section of the second recess 32 of the handle 3 is a right angle which is matched with the right angle of the right angle trapezoid of the fixture block 111, locking the handle 3 and making the handle 3 incapable of rotating relative to the body 2.

Usually the number of starts of the thread of the worm gear is one, which is a single start thread, and the speed of moving the jaw by rotating the worm gear is slow. The bearable torque of the worm gear with a single start thread is small. The worm gear of the wrench in the embodiment uses a double start thread structure, which reduces the time of adjusting the distance between jaws and increases the bearable torque of the worm gear.

The invention provides a wrench. When the handle is rotated anticlockwise relative to the body, the jaw locking mechanism switches from the locked state to the unlocked state. With the distance between the fixed jaw and the movable jaw increasing under the external force, the fixed jaw and the movable jaw are capable of slipping away from the apexes of the workpiece, to realizes rotating the workpiece continuously and repetitiously without moving the wrench away from the workpiece and placing the wrench to the workpiece again. Work efficiency of the wrench is improved. The structure is simple, being capable of bearing greater torque, simplifying the manufacturing process at the same time, and reducing the costs of manufacture. The first flexible member is internal, making the first flexible member avoid contacting with oil stain in use and the wrench more beautiful at the same time. The worm gear has a double-start thread structure, reducing the time of adjusting the distance between the jaws and at the same time increasing the bearable torque of the worm gear.

The above description details the preferable embodiments of the invention. It should be understood that with the general technique of this field, no inventive work is necessary as to make multiple amendments and changes according to conception of this invention. Therefore, all the technical schemes gained from logical analysis, deductions or limited experimentation based on the present invention by technicians in this field, should be considered within the protection range asserted in the Claims.

1. A wrench, comprising a body, a fixed jaw which is fixedly connected with the body, a movable jaw, a slidable connecting member and a handle which is rotatably connected with the body, the movable jaw forming a slidable connection with the body via the slidable connecting member, characterized in that the wrench comprises a jaw locking mechanism which is rotatably connected with the handle, and the jaw locking mechanism is used for restricting the slidable connecting member to move towards or away from the fixed jaw relative to the body;
when the handle rotates anticlockwise relative to the body, the handle drives the jaw locking mechanism from a locked state to an unlocked state, the movable jaw is capable of moving away from the fixed jaw under an external force.

2. The wrench as claimed in claim 1, wherein the body and the fixed jaw are integrated.

3. The wrench as claimed in claim 1, wherein the jaw locking mechanism is a knockout pin.

4. The wrench as claimed in claim 3, the slidable connecting member comprising a pin axle and a worm gear which is sleeved on the pin axle, wherein a first end of the pin axle which is away from the fixed jaw is provides with an annular groove around a surface of the pin axle, the jaw locking mechanism is in the locked state when the first end of the knockout pin is embedded in the annular groove, and the jaw locking mechanism is in the unlocked state when the first end of the knockout pin is detached from the annular groove.

5. The wrench as claimed in claim 4, wherein the worm gear is arranged in a cavity of the body, and the length of the worm gear is less than that of the cavity in the axial direction of the pin axle.

6. The wrench as claimed in claim 5, wherein a first flexible member is sleeved on a first end of the pin axle.

7. The wrench as claimed in claim 6, wherein the first flexible member is arranged in a hole of the body.

8. The wrench as claimed in claim 4, wherein a second end of the knockout pin and a first recess of the handle are rotatably connected.

9. The wrench as claimed in claim 8, wherein the second end of the knockout pin is a spherical structure.

10. The wrench as claimed in claim 8, wherein the second end of the knockout pin is a cylindrical structure, and the axis of the cylindrical structure is perpendicular to the axis of the knockout pin.

11. The wrench as claimed in claim 8, wherein the first recess of the handle is arc-shaped in profile.

12. The wrench as claimed in claim 11, wherein the corresponding central angle of the arc-shaped profile is larger than 180 degrees.

13. The wrench as claimed in claim 4, wherein the side of the handle facing to a first side of the body comprises a first side which is parallel to the first side of the body and a second side which forms an angle less than 5 degrees with the first side of the body.

14. The wrench as claimed in claim 13, wherein a blind hole is arranged on the second side of the handle, and a second flexible member is arranged in the blind hole.

15. The wrench as claimed in claim 4, wherein the worm gear has a double-start thread structure.

16. The wrench as claimed in claim 1, wherein the wrench comprises a handle locking mechanism, when the handle locking mechanism is in the locked state, the handle cannot be rotated relative to the body; when the handle locking mechanism is in the unlocked state, the handle is capable of rotating relative to the body.

17. The wrench as claimed in claim 16, wherein the handle locking mechanism comprises a push button and a fixture block, the push button is used for moving the handle locking mechanism between the locked position and the unlocked position, and the fixture block is used for limiting the rotation of the handle relative to the body.

18. The wrench as claimed in claim 17, wherein the fixture block matches with a second recess of the handle, so as to limit the rotation of the handle relative to the body.

19. The wrench as claimed in claim 18, wherein the cross section of the fixture block is right-angle trapezoid.

20. The wrench as claimed in claim 19, wherein the profile of the cross section of the second recess is a right angle which is matched with the right angle of the right-angle trapezoid of the fixture block.
